(19) United States
(12) Patent Application Publication
(10) Pub. No.: US 2019/0095775 A1
(43) Pub. Date: Mar. 28, 2019

(54) ARTIFICIAL INTELLIGENCE (AI) CHARACTER SYSTEM CAPABLE OF NATURAL VERBAL AND VISUAL INTERACTIONS WITH A HUMAN

(71) Applicant: VENTANA 3D, LLC, Van Nuys, CA (US)

(72) Inventors: Roman Lembersky, Van Nuys, CA (US); Michael James Borke, Upland, CA (US); Hayk Bezirganyan, Burbank, CA (US); Ashley Crowder, Culver City, CA (US); Benjamin Conway, Anaheim, CA (US); Hoang Son Vu, Winnetka, CA (US); James M. Behmke, Boston, MA (US)

(21) Appl. No.: 16/141,280

(22) Filed: Sep. 25, 2018

Related U.S. Application Data
(60) Provisional application No. 62/620,682, filed on Jan. 23, 2018.
(60) Provisional application No. 62/562,592, filed on Sep. 25, 2017.

(51) Int. Cl. G06N 3/00; G06F 15/18; G10L 25/63; G06K 9/00; G06T 13/40

(52) U.S. Cl. CPC G06N 3/008; G06F 15/18; G06T 13/40; G06K 9/00302; G10L 25/63

(57) ABSTRACT

Systems and methods herein are directed to an artificial intelligence (AI) character capable of natural verbal and visual interactions with a human. In one embodiment, an AI character system receives, in real-time, one or both of an audio user input and a visual user input of a user interacting with the AI character system. The AI character systems determines one or more avatar characteristics based on the one or both of the audio user input and the visual user input of the user. The AI character system manages interaction of an avatar with the user based on the one or more avatar characteristics.

### RELATED APPLICATIONS

The present application claims priority to U.S. Provisional Application No. 65/562,592, filed on Sep. 25, 2017 for ARTIFICIAL INTELLIGENCE CHARACTER CAPABLE OF NATURAL VERBAL AND VISUAL INTERACTIONS WITH A HUMAN, by Lembersky et al., and to U.S. Provisional Application No. 62/620,682, filed on Jan. 23, 2018 for ARTIFICIAL INTELLIGENCE CHARACTER CAPABLE OF NATURAL VERBAL AND VISUAL INTERACTIONS WITH A HUMAN, by Lembersky et al., the contents of both of which are hereby incorporated by reference.

### TECHNICAL FIELD

The present disclosure relates generally to computer-generated graphics, and, more particularly, to an artificial intelligence (AI) character capable of natural verbal and visual interactions with a human.

### BACKGROUND

The notion of advanced machines with human-like intelligence has been around for decades. Artificial intelligence (AI) is intelligence exhibited by machines, rather than humans or other animals (natural intelligence, NI), where the machine perceives its environment and takes actions that maximize its chance of success at some goal. Often, the term “artificial intelligence” is applied when a machine mimics “cognitive” functions that humans associate with other human minds, such as “learning” and “problem solving”. Traditional problems (or goals) of AI research include reasoning, knowledge, planning, learning, natural language processing, perception, and the ability to move and manipulate objects, while examples of capabilities generally classified as AI include successfully understanding human speech, competing at a high level in strategic game systems (such as chess and Go), autonomous cars, intelligent network routing, military simulations, and interpreting complex data.

Many tools are used in AI, including versions of search and mathematical optimization, neural networks and methods based on statistics, probability, and economics. The AI field draws upon computer science, mathematics, psychology, linguistics, philosophy, neuroscience, artificial psychology, and many others. Recently, advanced statistical techniques (e.g., “deep learning”), access to large amounts of data and faster computers, and so on, has enabled advances in machine learning and perception, increasing the abilities and applications of AI. For instance, there are many recent examples of personal assistants in smartphones or other devices, such as Ski® (by Apple Corporation), “OK Google” (by Google Inc.), Alexa (by Amazon), automated online assistants providing customer service on a web page, etc., that exhibit the increased ability of computers to interact with humans in a helpful manner.

Natural language processing, in particular, gives machines the ability to read and understand human language, such as for machine translation and question answering. However, the ability to recognize speech as well as humans is a continuing challenge, since human speech, especially during spontaneous conversation, is extremely complex, especially where littered with stutters, ums, and mumbling. Furthermore, though AI has become more prevalent and more intelligent over time, the interaction with AI devices still remains characteristically robotic, impersonal, and emotionally detached.

### SUMMARY

According to one or more embodiments herein, systems and methods for an artificial intelligence (AI) character capable of natural verbal and visual interactions with a human are shown and described. In particular, various embodiments are described that convert speech to text, process the text and a response to the text, convert the response back to speech and associated lip-syncing motion, face emotional expression, and/or body animation/position, and then display the response speech through an AI character. Specifically, the techniques herein are designed to engage the users in the most natural and human like way (illustratively as a three-dimensional (3D) holographic character model), such as based on perceiving the user's mood/emotion, eye gaze, and so on through capturing audio input and/or video input of the user. The techniques herein also can be implemented as a personal virtual assistant, tracking specific behaviors of particular users, and responding accordingly.

In one particular embodiment, for example, an AI character system receives, in real-time, one or both of an audio user input and a visual user input of a user interacting with the AI character system. The AI character system then determines one or more avatar characteristics based on the one or both of the audio user input and the visual user input of the user. As such, the AI character system may then manage interaction of an avatar with the user based on the one or more avatar characteristics.

According to one or more particular embodiments herein, the AI character capable of natural verbal and visual interactions with a human may be specifically for financial services settings, for example, configured as a bank teller or a concierge (e.g., for a hospitality setting). In particular, in addition to financial service representative interaction and intelligence, certain embodiments of the techniques herein may also provide for application programming interface (API) calls to complete financial transactions, connectivity to paper-based financial systems, and advanced biometric security and authentication measures.

Other specific embodiments, extensions, or implementation details are also described below.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example artificial intelligence character (AI) system for managing interaction of an avatar based on input of a user;

FIGS. 2A-2B illustrate example meshes for phonemes and morph targets that express phonemes for morph target animation;

FIG. 3 illustrates an example of three-dimensional (3D) bone based rigging;

FIG. 4 illustrates a device that represents an illustrative AI character and/or avatar interaction and management system;

FIGS. 5A-5B illustrate various visual points of a user that may be tracked by the systems and method described herein;

FIG. 6 illustrates an example holographic projection system;

FIGS. 7A-7B illustrate alternative examples of a holographic projection system;

FIG. 8 illustrates an example interactive viewer experience;

FIG. 9A-9B illustrates an example AI character system capable of natural verbal and visual interactions that is specifically configured as a bank teller in accordance with one or more embodiments herein;

FIG. 10 illustrates an example simplified procedure for managing interaction of an avatar based on input of a user; and

FIG. 11 illustrates another example simplified procedure for managing interaction of an avatar based on input of a user, particularly based on financial transactions.

### DESCRIPTION OF EXAMPLE EMBODIMENTS

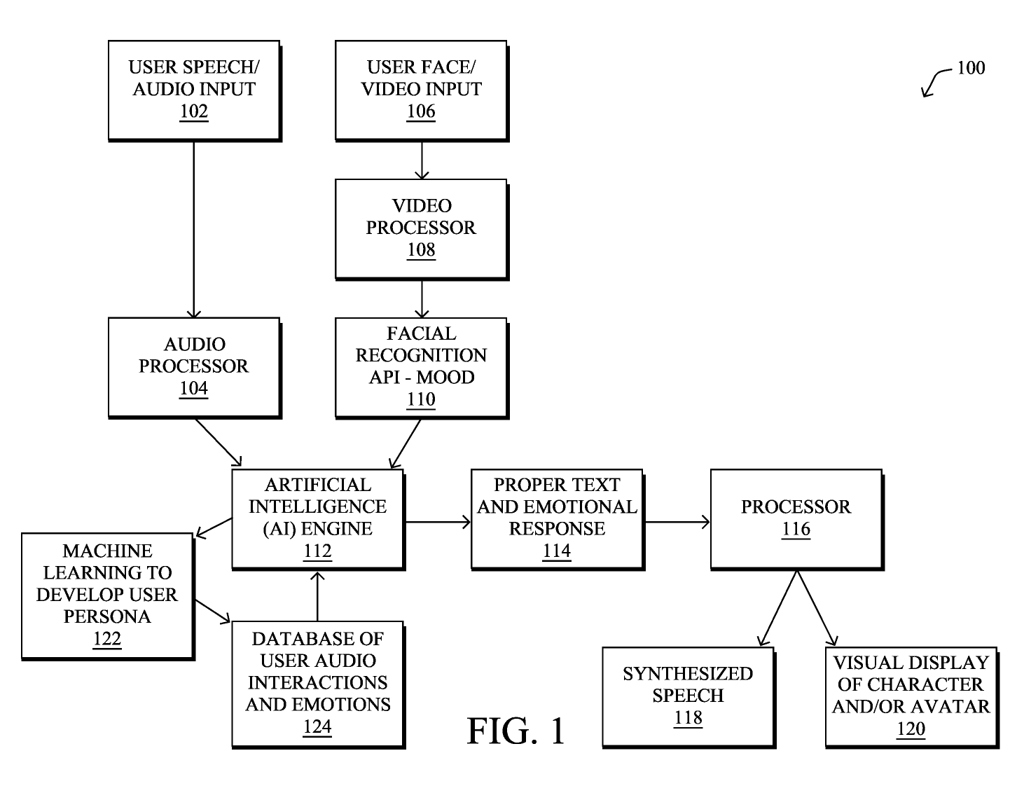

The techniques herein provide an AI character or avatar capable of natural verbal and visual interactions with a human. In particular, the embodiments herein are designed to engage users in the most natural and human-like way, presenting an AI character or avatar that interacts naturally with a human user, like speaking with a real person. With reference to FIG. 1, an AI character system 100 for managing a character and/or avatar is shown. In particular, the techniques herein receive user input (e.g., data) indicative of a user's speech 102 through an audio processor 104 (e.g., speech-to-text) and of a user's face 106 through a video processor 108. Also, through a facial recognition API 110 and/or skeletal tracking, the techniques herein can determine the mood of the user. The user's converted text (speech) and mood 110 may then be passed to an AI engine 112 to determine a proper response 114 to the user (e.g., an answer to a question and specific emotion), which results in the proper text and emotional response being sent to a processor 116, which then translates the responsive text back to synthesized speech 118, and also triggers visual display “blend shapes” 120 to morph a face of the AI character or avatar (two-dimensional (2D) display or even more natural three-dimensional (3D) holograph) into a proper facial expression to convey the appropriate emotional response and mouth movement (lip synching) for the response. If the character has a body, this can also be used to translate the appropriate body movement or position. For example, if the user is upset, the character might slouch its shoulders, clasp its hands, and/or respond in a calm voice. Illustratively, the AI character or avatar may be based on any associated character model, such as a human, avatar, cartoon, or inanimate object character. Characters/avatars may generally take either a 2D form or 3D form, and may represent humanoid and anthropomorphized non-humanoid computer-animated objects. Notably, as described below, the system may also apply machine learning tools and techniques 122 to store a database of emotions and responses 124 for a particular user, in order to better respond to that particular user in the future.

The first component of the techniques herein is based on audio and video machine perception. Typical input sensors comprise microphones, video capture devices (cameras), etc., though others may also be used, such as tactile sensors, temperature sensors, etc.). The techniques herein may then send the audio and video inputs 102, 106 (and others, if any) to audio and video processing algorithms in order to convert the inputs. For instance and with reference to user's speech 102 (that can be captured by a microphone, the audio processor 104 can use an application programming interface (API) where the audio input 102 may be sent to a speech recognition engine (e.g., IBM's Watson or any other chosen engine) to process the user speech and convert it to text.

The video input 106, on the other hand, may be sent to a corresponding video processing engine for “affective computing”, which can recognize, interpret, and process human affects. For example, based on psychology and cognitive science, the video processor 108 and/or the facial recognition API 110 can interpret human emotions (e.g., mood) and adapts its behavior to give an appropriate response to those emotions. In general, emotions of the user may be categories in the API 110 (or any other database) and be selected based on the audio input 102 and/or the video input 106 (after processing by processors). As discussed academically, that is, emotion and social skills are important to an intelligent agent for two reasons. First, being able to predict the actions of others by understanding their motives and emotional states allow an agent to make better decisions. Concepts such as game theory, decision theory, necessitate that an agent be able to detect and model human emotions. Second, in an effort to facilitate human-computer interaction, an intelligent machine may want to display emotions (even if it does not experience those emotions itself) to appear more sensitive to the emotional dynamics of human interaction.

The text generated above may then be sent to the AI engine 112 (e.g., the Satisfi Labs API or any other suitable API) to perform text processing to return an appropriate response based on the user intents. For example, simpler systems may detect keywords to recognize (e.g., “food”) and to associate a response based on similar intents (e.g., listing local restaurants), which generally consist of a limited list of intents that are hardcoded. A more complex system may learn questions and responses over time (e.g., machine learning). In either case, the response 114 may then be associated with a prerecorded (hardcoded) audio file, or else may have the text response converted dynamically to speech.

According to the techniques herein, the text/speech response 114 may be processed by the processor 116 to match mouth movement to the words (e.g., using the Lip-Syncing Plugin for Unity, as will be appreciated by those skilled in the art). For instance, the system 100 shown in FIG. 1 may take an audio file and break it down into timed sets of sounds, and then associate that with a predefined head model “morph target” or “blend shapes” (as described below) that make the head model of an character and/or avatar look like it is talking. That is, as detailed below, a rigged model may be defined that has morph targets (mouth positions) that match the sounds.

Additionally, one or more embodiments of the techniques herein also analyze the user's mood based on the emotions on the user's face via facial recognition (based on the video input 106), as mentioned above, as well as contextually based on the speech itself, for example, words, tone, etc. (based on the audio input 102). In particular, the AI character (e.g., hologram/3D model) may thus be configured to respond in the appropriate facial emotions and voice. For example if the user is worried, the AI character may respond in a calming way and ask how they can help and will find appropriate responses or suggestions or can ask more follow up questions to help. The techniques herein, therefore, provide an automated emotion detection and response system that can take any model that is rigged in a certain way (has all the necessary emotional stats and proper animations as well as the voice type) and cause it to respond in the most intuitive way to keep the user engaged in the most natural manner.

Note that in still further embodiments, the audio from the user may be used to additionally (or alternatively) allow the system to detect a user's emotions, such as through detecting tone, volume, speed, timing, and so on of the audio, in addition to the words (text) actually spoken. For example, someone saying the words “I need help” can be differently interpreted emotionally by the system herein based on whether the user politely and calmly says “I need help” when prompted, versus yelling “I NEED HELP” before a response is expected. AI engine 112 may thus be configured to consider all inputs available to it in order to make (and learn) determinations of user emotion.

Illustratively, the techniques herein thus analyze sentiment of the user, and may correspondingly adjust the response, tone, and/or expression of the AI character, as well as changing the AI character (or avatar type) itself. For instance, a child lost in a mall may approach the system herein, and based on detecting a worried child, may appear as a calming and concerned cartoon character, who can help the child calm down and find his or her parents and the algorithm will specifically cause the face of the character to furrow it's brow out of concern. Alternatively, if an adult user approaches the system, and the user is correlated to a user that frequents the athletic store in the mall, a sports star character may be used. The sports star may then base his or her facial expressions on the user's perceived emotion, such as smiling if the user is happy, or calming if the user is upset, or shocked if the user says something shocking to the system, etc. (Notably, any suitable response to the user may be processed, and those mentioned herein are merely examples for illustration.)

The techniques herein may also employ body tracking to ensure that the AI character maintains eye contact throughout the entire experience, so it really feels like it is a real human assistant helping. For instance, the system may follow the user generally, or else may specifically look into the user's eyes based on tracked eye gaze of the user.

According to one or more specific embodiments of the techniques herein, the natural AI character system may provide a personalized network, where a user-based platform allows a user to register as part of a virtual assistance network. This incorporates machine learning on top of AI so the virtual assistant can learn more about the user and make appropriate responses based on their past experiences. For instance, the techniques herein may collect for example, a historical activity database, the sentiment from the user using facial recognition, and stores this in their emotional history in the database of emotions and responses 124 for a particular user. The machine learning tools and techniques 122 may then be used to improve the virtual assistant's responses based on the user's past experiences such as shopping and dining habits from questions they ask the virtual assistant. The user will then be able to receive personalized greetings and suggestions.

As an example, assume that a user “John” is registered and has a birthday today. The virtual assistant may congratulate John and will offer some Birthday Coupons from some of his favorite stores or restaurants in a festive manner. This network will also allow merchants to register as data providers that can help the assistant to learn more about the user's activity. As another example, therefore, the system may learn about the clothing size John wears, and the calories he consumed while eating at the food court for any restaurants. The virtual assistant may then suggest lighter food if the user John set in his preferences to help him to watch after his diet. Furthermore, based on the user's profile the virtual assistant can be a targeted personal advertisement directed at the user from the stores in the system. For example, the virtual assistant could suggest salad place to eat based on John's information and give an excited look and encouraged tone to stay on the diet.

These are very specific examples, and the techniques herein may be applied in any suitable manner to assist the user and to make the user feel more comfortable asking for help from the assistant that recognizes the user. Facial recognition may be used to identify the user and associate the interaction with the user's personalized data. Behind the scenes, machine learning algorithms may process the data (from the particular user especially, but also from all users generally), and generate appropriate user responses on the short time period bases.

As referenced above, the following description details the methodology a client can use to upload unique visual and audio files into a system to create an interactive and responsive “face” and/or “character” that can be utilized for a variety of purposes.

Note: for the purposes of this document, the following words will be defined as follows:
Client: someone who would be putting the necessary assets for the automation process, such as a representative of a company who wants to use software that implements the systems and methods described herein with their own assets.
User: someone who will be interacting with the AI character once it is completed.

Illustratively, the techniques herein may be based on the known Unity build software, which combines the 3D files (e.g., in the following formats: .fbx, .dae, .3ds, .dxf, .obj, and .skp) and the audio files (in the following format: .wav) into an interactive holographic “face” and/or full body “character”, which can then interact with users. The 3D files would create a visual interface, while the audio files would be pre-determined responses to user inquiry, determined as described above. Additionally, instead of predetermined audio files, the software can also mimic the real-time audio input of a user. Generally, the AI character system 100 can store or categorize emotions of characters and/or avatars into selectable groups that can be selected based on the determined mood of a user (indicated by audio and/or visual input of the user). For example, a database can store and host the emotions of the characters. Further, one or more characteristics of the characters and/or avatars may be modified and are generated to alter the response, appearance, expression, tone, etc. of the characters and/or avatars.

Clients can control or manage a variety of factors: which inquiries generate which response, additional 3D or 2D visuals that can “appear” in the image (e.g., hologram), etc. This is done by a variety of methods, which are outlined here:

Method 1: Using Morph Targets

Morph Target Animation (also known as Blend Shapes) is a technique where a 3D mesh can be deformed to achieve numerous pre-defined shapes of any number of combinations of the in-between of shapes. For example, a mesh (a collection of vertices, edges, and faces that describe the shape of a 3D object, essentially something 3D) called “A” would just be a face with the mouth closed in a neutral manner. A mesh called “B” would be the same face with the mouth open to make an “0” sound. Using morph target animation the two meshes are “merged” so to speak, and the base mesh (which is the neutral closed mouth) can be morphed into an “0” shape seamlessly. This method allows a variety of combinations to generate facial expressions, and phonemes.

Requirements for Morph Target Animation that could be implemented are:

1) There must be a “base” mesh, which would act as the starting point of all the morph targets (blend shapes). This mesh would morph into the additional morph targets.

2) All morph targets must maintain the exact number of triangles (the number of triangles that make up a 3D model—as all 3D Models are composed of hundreds if not millions of triangles), for the process to work. In an example, if the base mesh has 5,000 triangles, all additional morph target meshes must also have 5,000 triangles.

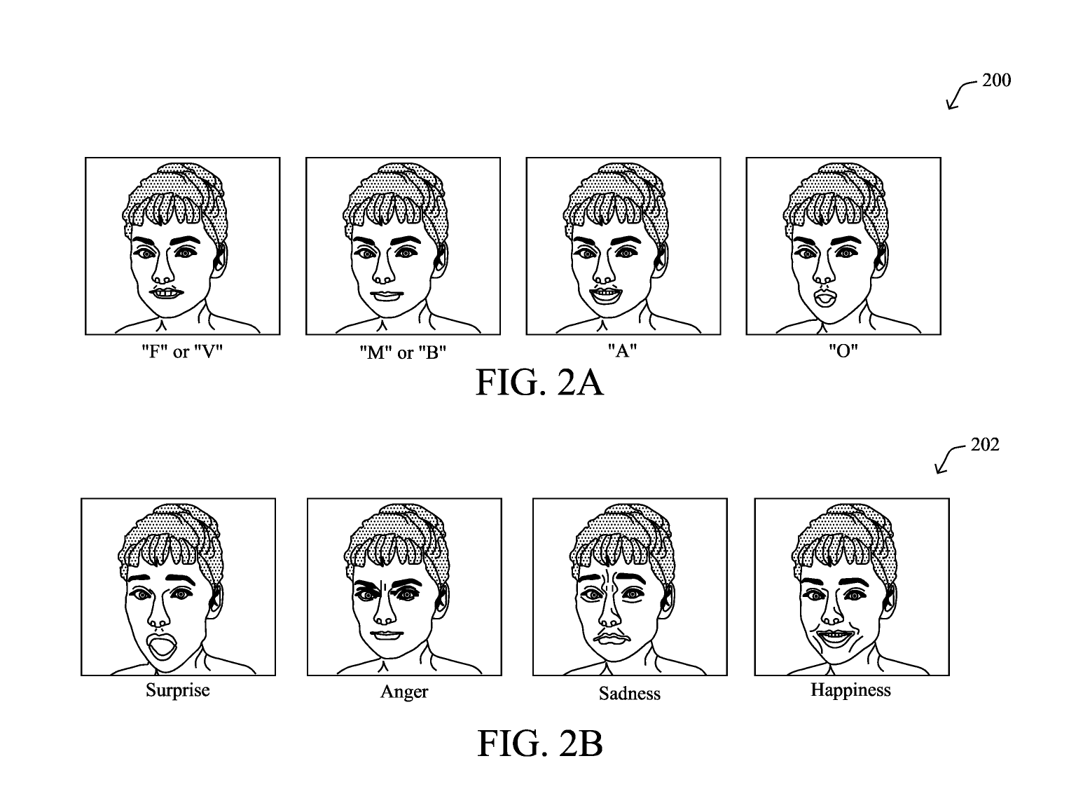

3) There must be a separate mesh for the following phonemes: A, E, O, U, CDGKNSThYZ, FV, L, MBP, WQ. FIG. 2A illustrates example meshes 200 for phonemes. The base mesh would morph into any of these different phonemes 200 based on the input of the audio (speech).

4) To make the face more realistic and natural, the client must upload additional morph targets that express emotions, for example, eyebrows raising, eyebrows furrowing, frowning, smiling, closing the eyes, blinking. FIG. 2B illustrates example morph targets 202. These morph targets would allow the holographic face to have more expressive features. These morph targets must also use the proper naming convention to be plugged into software that implements the methods and systems described herein. In an example system, to read a morph target as a “happy” emotion, the client could name it emote_happy.

5) For additional realism, such as head tilting, nodding, etc., a client can upload custom animations with their 3D File as long as it is rigged (the model has a “bone” structure, allowing it to be animated) and skinned (telling the “bones” how different parts of the model are affected by the given “bone”) needs to be made as well.

6) Most models also need the relevant materials, which read how textures (skin color, eye color, hair color as examples) would be interpreted. These must be properly named, for example, in a universal or proprietary naming convention scheme, to be properly assigned to the model.

7) AI and machine learning processes can then be implemented to morph the face bones into the proper emotional response based on the user's emotional state. (That is, the response articulation algorithms may be used to adjust the articulation of the character to match the context and the sentiment.) For example an ‘ou’ sound may be presented in different shapes depending on the sentiment and emotion.

An illustrative example procedure associated with this method is as follows:

Step 1: Client uploads a base mesh, along with any relevant materials.

Step 2: Client must upload the phoneme morph targets, and choose an available language package which would translate and understand how to properly use the morph targets to form words, assigning the morph targets to the proper phoneme.

Step 3: Client must upload the additional emotion based morph targets.

Step 4: If the model has animations assigned to it, the Client must define which frames correspond to which proper animation.

Step 5: If there are any additional models that are not necessarily part of a morph target model (such as a pasta dish, a football, etc.) these must be uploaded with their own relevant materials and proper naming convention.

Step 6: If there are pre-recorded audio responses, those audio files must also be uploaded.

Step 7: Client must define which audio responses would receive which animation, and initial emotion (for example, an audio where there is a statement “You can find the store on level 3” the user can apply a “happy” emotion, and a “nod” animation. Or, if the response is “Can you repeat the inquiry?” the user can apply an “inquisitive” emotion and a “head tilt” animation. This gives additional natural feel to the holographic face. These emotional responses will change over time based as the AI learns through multiple user interactions with machine learning to improve the response. The emotional responses can also be programmed more generally so all user questions have a “happy” response.

Step 8: The Client must define “trigger” words, words or phrases that would trigger a particular response. Then apply these trigger words to the proper responses. So when a user interacts with the hologram and says a particular word such as “food” it will trigger a proper response such as “The food court is located on level 3”.

Step 9: A Client can also assign the additional models from Step 5 to the above mentioned responses. Using the example from Step 8 the client can include a pasta bowl or a hamburger 3D model or 2D image to “pop up” during the response.

Method 2: Using Bone Based Rig

Besides morph targets (blend shapes), a client can upload a model that is primarily rigged with bones. In its simplest form, 3D rigging is the process of creating a skeleton for a 3D model so it can move. Most commonly, characters are rigged before they are animated because if a character model doesn't have a rig, they can't be deformed and moved.

Similar to uploading morph targets, the user must upload a model that has the bones properly showing the key phonemes of A, E, O, U, CDGKNSThYZ, FV, L, MBP, WQ.

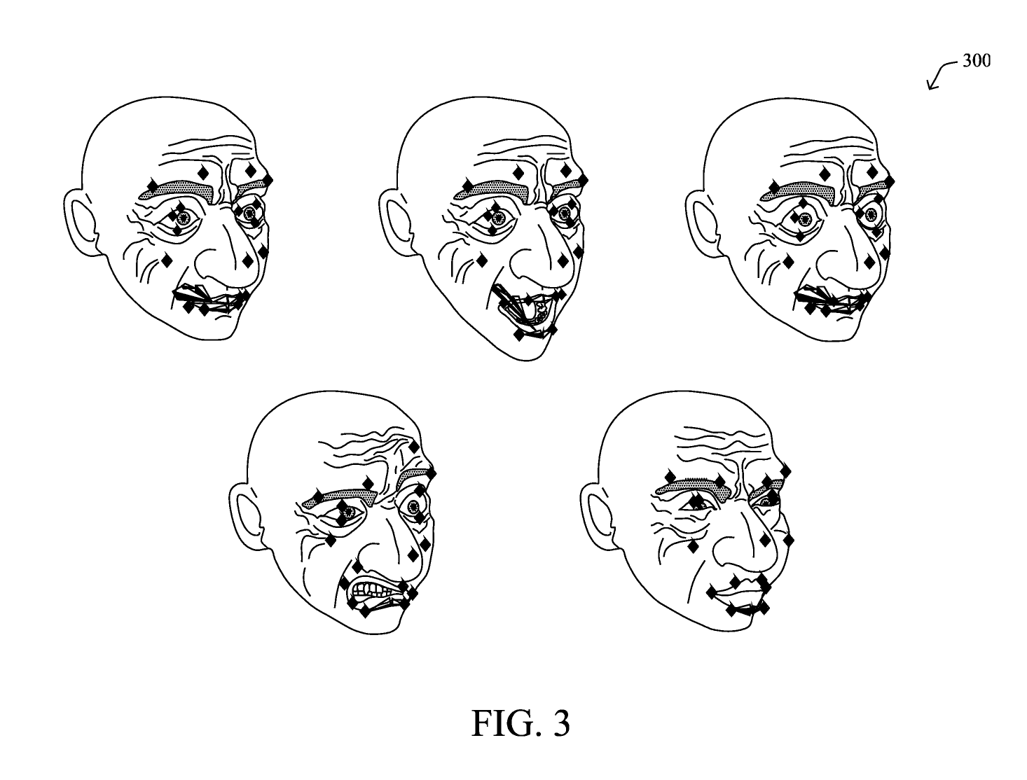

However, unlike morph targets, the client does not have to upload a separate model for each phoneme, but instead define the rotation, and position of the relevant bones which form the shapes. FIG. 3 illustrates 3D bone based rigging 300. As shown, the diamond shapes are the bones, which control different parts of the 3D face and are posed for the different expressions.

Requirements for bone based 3D rigging that could be implemented are:

1) The model must be properly skinned, which means that the bones affect the 3D object properly and efficiently.

2) The model must then process the position and rotation of the bones to be set for proper phonemes. This is usually done by animations frame, so for example: Frame 1 would be a neutral face. Frame 2 would have the pose of the face making an “0” sound. Frame 3 would have the pose of a face making a “U” sound.

3) The model must have the proper poses for any emotional expression.

4) Like the morph target (blend shape) method, if the model has any animations they must be properly created and defined, with the proper naming conventions.

5) Any relevant materials must be also defined properly and applied properly.

An illustrative example procedure associated with this method is as follows:

Step 1: Client uploads a skinned mesh that has the proper bones and poses assigned.

Step 2: Client must define which poses apply to which phonemes. The client also chooses an available language package which would translate and understand how to properly use the poses to form words.

Step 3: Client must upload the additional emotion based poses.

Step 4: If the model has animations assigned to it, the Client must define which frames correspond to which proper animation for the initial facial expressions for each response. These emotional responses will change over time as the AI learns through multiple user interactions with machine learning to improve the response.

Step 5: If there are any additional models that are not necessarily part of a skinned model (such as a pasta dish, a football, etc.) these must be uploaded with their own relevant materials.

Step 6: If there are pre-recorded audio responses, those audio files must also be uploaded.

Step 7: Like the method with morph targets: Client must define which audio responses would receive which animations, and emotions initially. These emotional responses will change over time as the AI learns through multiple user interactions with machine learning to improve the response.

Step 8: The Client must define “trigger” words, words or phrases that would trigger a particular response. Then apply these trigger words to the proper responses.

Step 9: A Client can also assign the additional models from Step 5 to the above mentioned responses.

According to one or more embodiments herein, the display may comprise a television (TV), a monitor, a light-emitting diode (LED) wall, a projector, liquid crystal displays (LCDs), augmented reality (AR) headset, or virtual reality (VR) headset, light field projection, or any similar or otherwise suitable display. For instance, as described in greater detail below, the display may also comprise a holographic projection of the AI character, such as displaying a character as part of a “Pepper's Ghost” illusion setup, e.g., allowing an individual to interact with a holographic projection of a character.

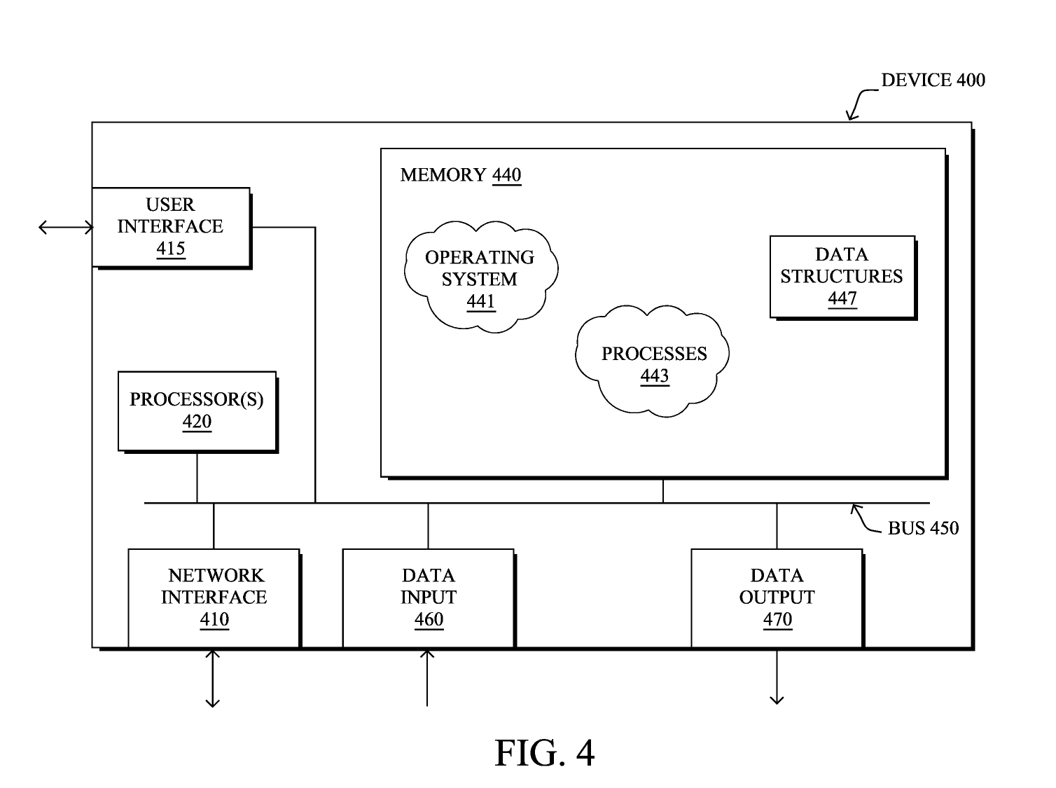

FIG. 4 illustrates an example simplified block diagram of a device 400 that represents an illustrative AI character and/or avatar interaction and management system. In particular, the simplified device 400 may comprise one or more network interfaces 410 (e.g., wired, wireless, etc.), a user interface 415, at least one processor 420, and a memory 440 interconnected by a system bus 450. The memory 440 comprises a plurality of storage locations that are addressable by the processor 420 for storing software programs and data structures associated with the embodiments described herein. The processor 420 may comprise hardware elements or hardware logic adapted to execute the software programs and manipulate the data structures 447.

Note that the processing system device 400 may also comprise an audio/video feed input 460 to receive the audio input and/or video input data from one or more associated capture devices, and a data output 470 to transmit the data to any external processing systems. Note that the inputs and outputs shown on device 400 are illustrative, and any number and type of inputs and outputs may be used to receive and transmit associated data, including fewer than those shown in FIG. 4 (e.g., where input 460 and/or output 470 are merely represented by a single network interface 410).

An operating system 441, portions of which are resident in the memory 440 and executed by the processor, may be used to functionally organize the device by invoking operations in support of software processes and/or services executing on the device. These software processes and/or services may comprise, illustratively, such processes 443 as would be required to perform the techniques above. In terms of functionality, the processes 443 contain computer executable instructions executed by the processor 420 to perform various features of the system described herein, either singly or in various combinations. It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown as a single process, those skilled in the art will appreciate that processes may be routines or modules within other processes and/or applications, or may be separate applications (local and/or remote).

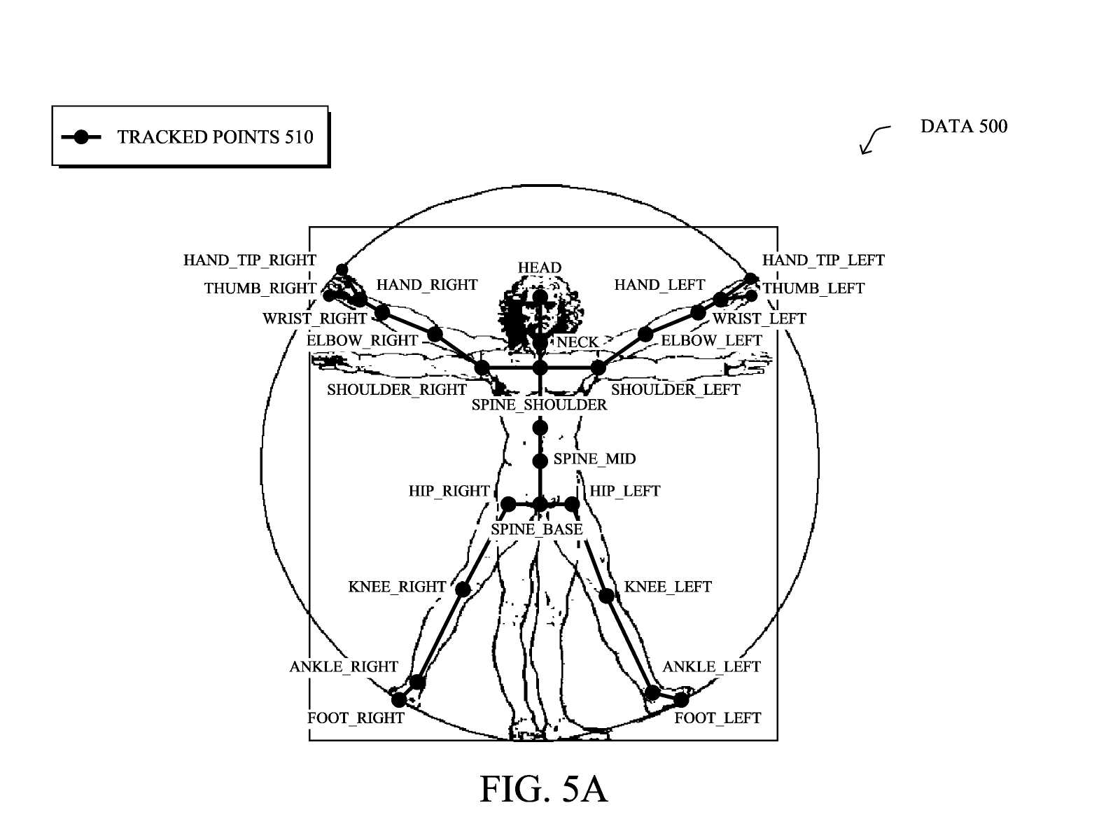

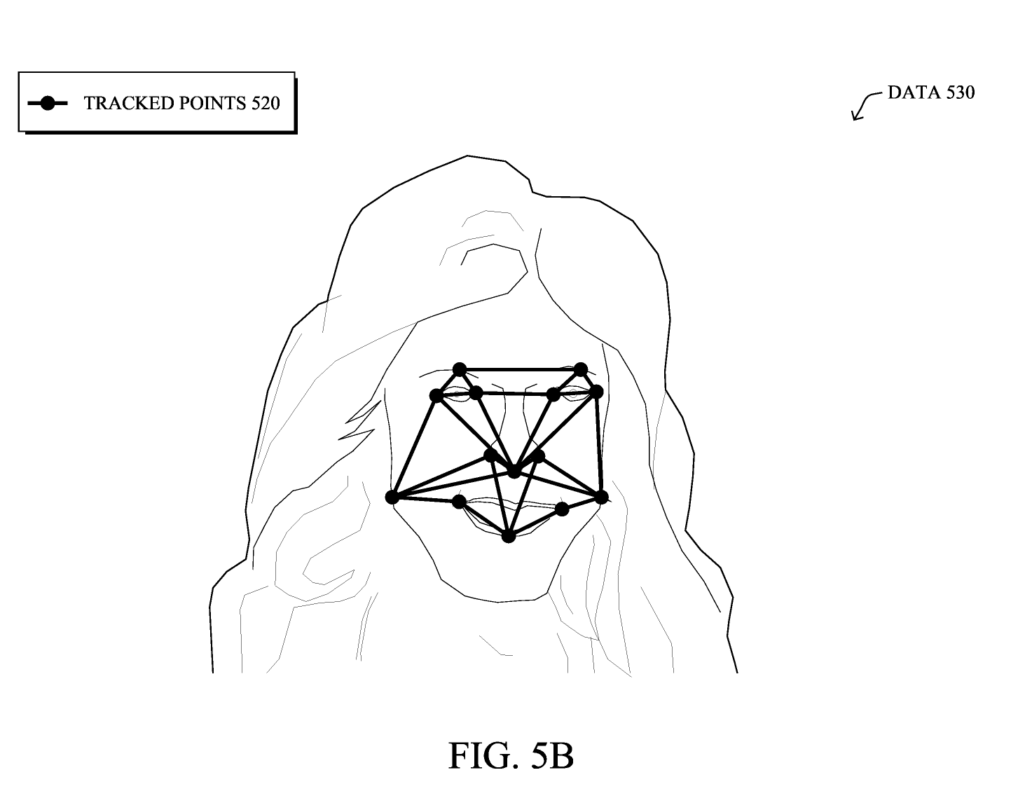

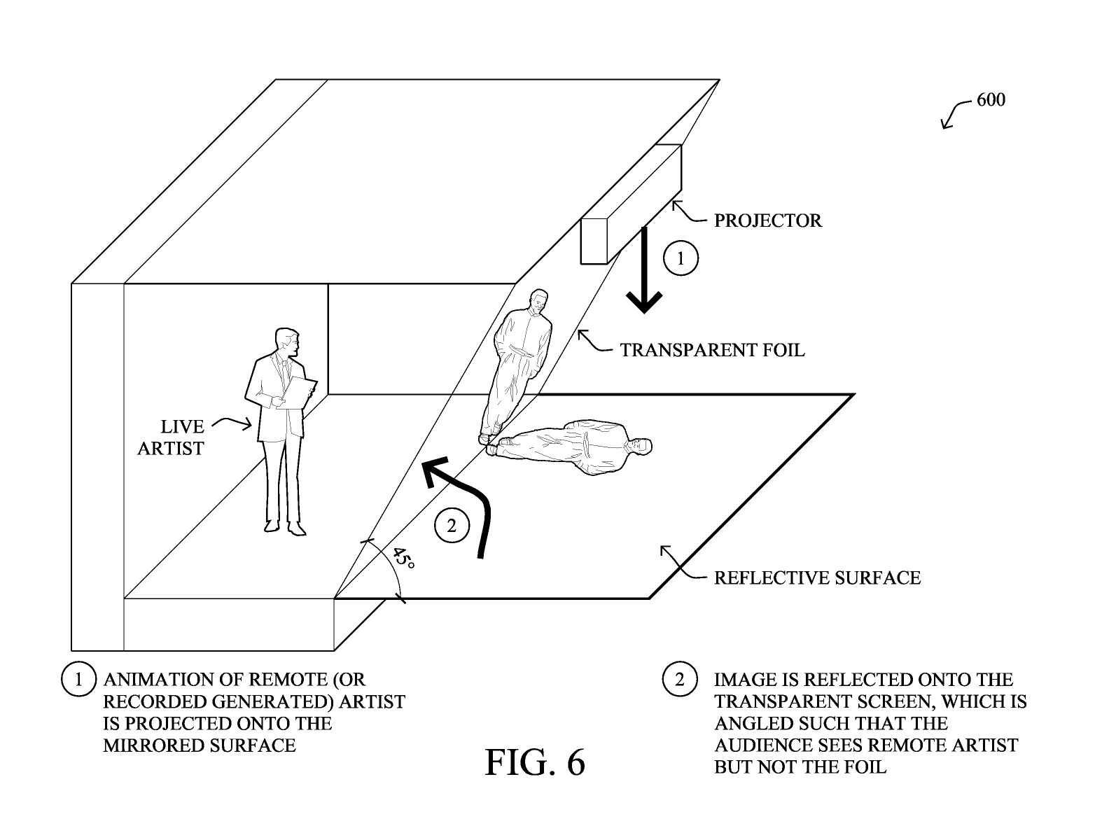

According to one aspect of the present invention, a mapping process, illustratively built on the Unity software platform, takes 3D models/objects (e.g., of “Filmbox” or “.fbx” or “FBX” file type) and maps the model's specified points (e.g., joints) to tracking points (e.g., joints) of a user that are tracked by the video processing system (e.g., a video processing process in conjunction with a tracking process). Once the positions and movements of the user are mapped, the user's facial expression may then be determined, as described herein. Though various video processing systems can track any number of points, the illustrative system herein (e.g., the KINECT™ system) is able to track twenty-five body joints and fourteen facial joints, as shown in FIGS. 5A and 5B, respectively. In particular, as shown in FIG. 5A, data 500 (video data) may result in various tracked points 510 comprising primary body locations (e.g., bones/joints/etc.), such as, e.g., head, neck, spine_shoulder, hip_right, hip_left, etc. Conversely, as shown in FIG. 6B, tracked points 520 may also or alternatively comprise primary facial expression points arise from data 530, such as eye positions, nose positions, eyebrow positions, and so on. Again, more or fewer points may be tracked, and those shown herein (and the illustrative KINECT™ system) are merely an illustrative example.

Notably, the specific technique used to track points 510, 520 is outside the scope of the present disclosure, and any suitable technique may be used to provide the tracked/skeletal data from the video processing system. In particular, while FIGS. 5A and 5B illustrate point-based tracking, other devices can be used with the techniques herein that are specifically based on skeletal tracking, which can reduce the number of points needed to be tracked, and thus potentially the amount of processing power needed.

An example holographic projection system according to one or more embodiments described herein generally comprises hardware that enables holographic projections based on the well-known “Pepper's Ghost Illusion”. In particular, though many holographic techniques may be used, an illustrative system based on the Pepper's Ghost Illusion is shown in FIG. 6, illustrating an example of a holographic projection system 600. Particularly, the image of the AI character and/or avatar (or other object) may be projected onto a reflective surface, such that it appears on a screen angled and the audience sees the person or object and not the screen (e.g., at approximately 45 degrees). If the screen is transparent, this allows for other objects, such as other live people, to stand in the background of the screen, and to appear to be standing next to the holographic projection when viewed from the audience.

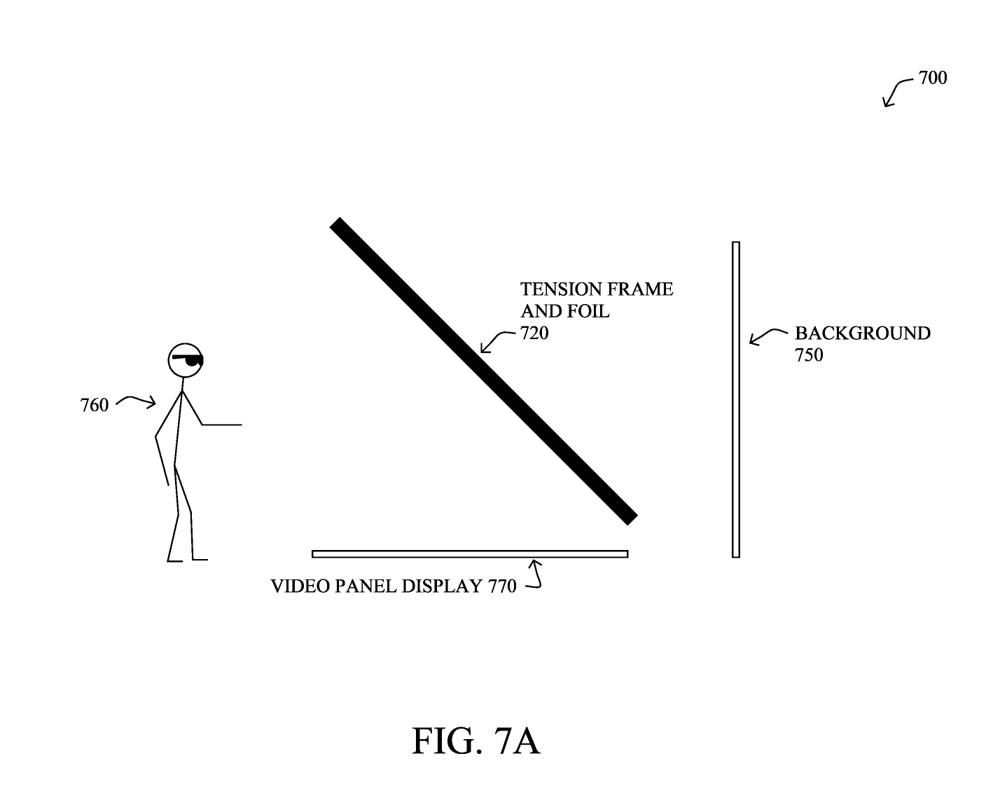

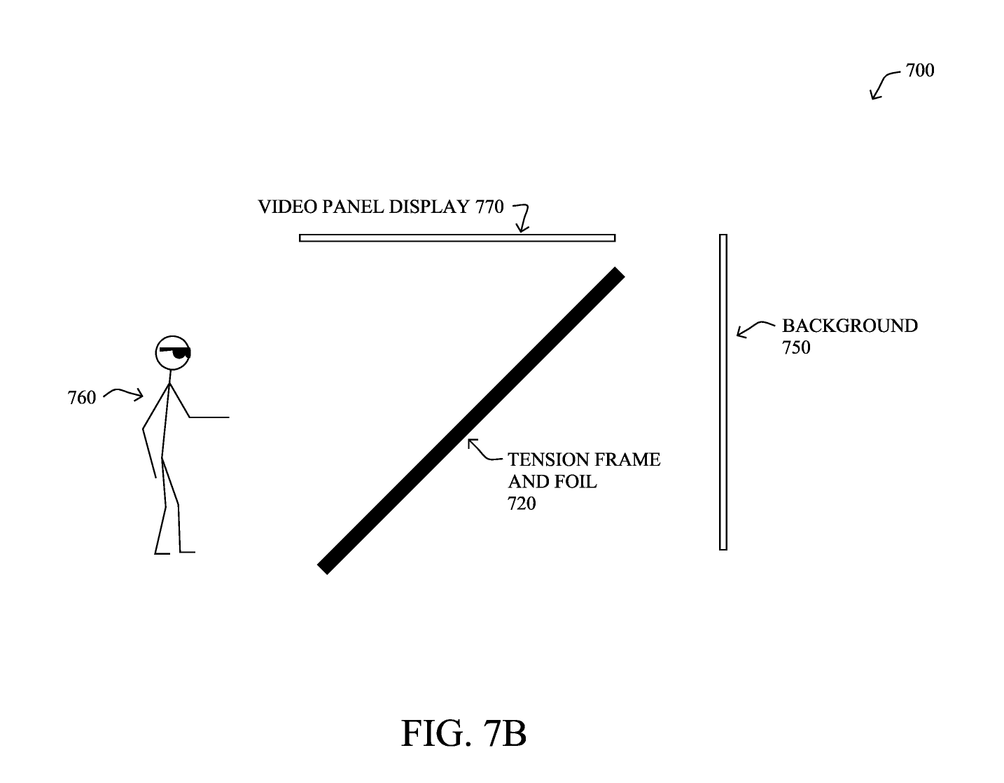

In addition to projection-based systems, according to one or more embodiments of the invention herein, and with reference generally to FIGS. 7A and 7B, the hologram projection system 700 may be established with an image source 770, such as video panel displays, such as LED or LCD panels as the light source. The stick FIG. 760 illustrates the viewer, that is, from which side one can see the holographic projection in front of a background 750. (Notably, the appearance of glasses on the stick FIG. 760 is not meant to imply that special glasses are required for viewing, but are merely to illustrate the direction the figure is facing.)

The transparent screen 720 is generally a flat surface that has similar light properties of clear glass (e.g., glass, plastic such as Plexiglas or tensioned plastic film). As shown, a tensioning frame may be used to stretch a clear foil into a stable, wrinkle-free (e.g., and vibration resistant) reflectively transparent surface (that is, displaying/reflecting light images for the holographic projection, but allowing the viewer to see through to the background). Generally, for larger displays it may be easier to use a tensioned plastic film as the reflection surface because glass or rigid plastic (e.g., Plexiglas) is difficult to transport and rig safely.

The light source itself can be any suitable video display panel, such as a plasma screen, an LED wall, an LCD screen, a monitor, a TV, etc. When an image (e.g., stationary or moving) is shown on the video display panel, such as a person or object within an otherwise black (or other stable dark color) background, that image is then reflected onto the transparent screen (e.g., tensioned foil or otherwise), appearing to the viewer (shown as the stick figure) in a manner according to Pepper's Ghost Illusion.

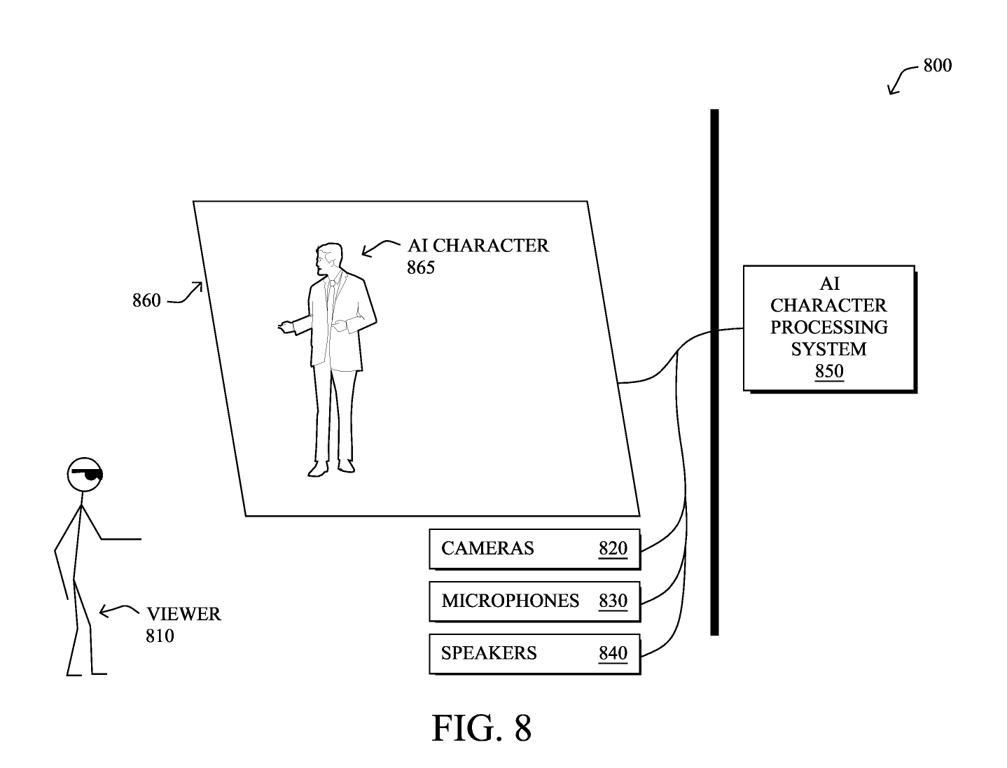

According to the techniques herein, therefore, such holographic projection techniques may be used as a display to create an interactive viewer experience. For example, as shown in FIG. 8, the interactive viewer experience 800 allows a viewer 810 can interact with an AI character 865. For instance, various cameras 820, microphones 830, and speakers 840 may allow the viewer 810 to interact with the AI character 865, enabling the system herein (AI character processing system 850) to respond to visual and/or audio cues, hold conversations, and so on, as described above. The avatar 865 may be, for example, a celebrity, a fictional character, an anthropomorphized object, and so on.

Notably, according to one or more embodiments herein, depth-based user tracking allows for selecting a particular user from a given location that is located within a certain distance from a sensor/camera to control an avatar. For example, when many people are gathered around a sensor or simply walking by, it can be difficult to select one user to control the avatar, and further so to remain focused on that one user. Accordingly, various techniques are described (e.g., depth keying) to set an “active” depth space/range.

In particular, the techniques herein visually capture a person and/or object from a video scene based on depth, and isolate the captured portion of the scene from the background in real-time. For example, as described in commonly owned U.S. Pat. No. 9,679,369 (issued on Jun. 13, 2017), entitled “Depth Key Compositing for Video and Holographic Projection”, by Crowder et al. (the contents of which incorporated by reference herein in its entirety), special depth-based camera arrangements may be used to isolate objects from captured visual images.

Advantageously, the techniques herein provide systems and methods for an AI character capable of natural verbal and visual interactions with a human. In particular, as mentioned above, the techniques described herein add life and human-like behavior to AI characters in ways not otherwise afforded. Though AI-based computer interaction has been around for years, the additional features herein, namely the psychological aspects of the AI character's interaction (responses, tones, facial expression, body language, etc.) provide greater character depth, in addition to having a holographic character to appear to exist in front of you. In addition, machine learning can be used to analyze all user interactions to further improve the face emotional response and verbal response over time.

AI Character Systems with Bank Teller Avatar for Financial Transaction(s)

According to one or more additional embodiments herein, the AI character system described above may also be configured specifically as a bank teller, with associated physical interfaces (e.g., connectivity to paper-based financial systems) and advanced security measures (e.g., for advanced biometric security and authentication).

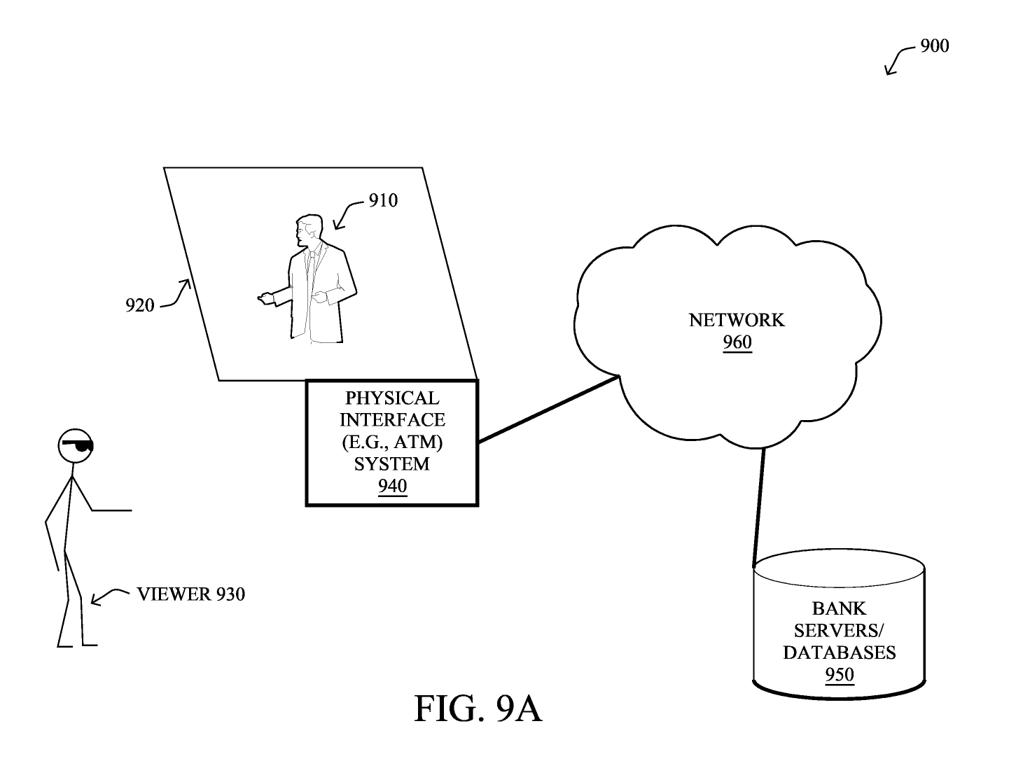

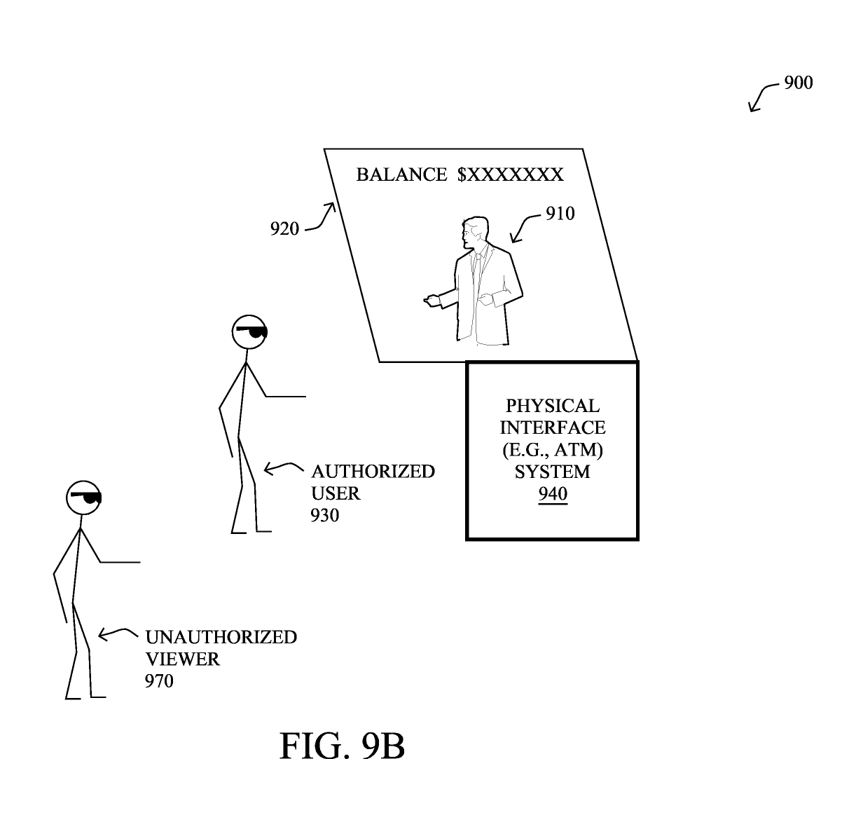

In particular, and with reference generally to FIG. 9A, the AI character system 900 herein may be embodied to interact as a financial advisor, bank teller, or automated teller machine (ATM), where the interaction intelligence of the AI character 910 can be displayed in a display 920 and can be configured to coordinate with financial accounts (e.g., bank accounts, credit card accounts, etc.) of an authorized user 930, and with one or more associated physical interface systems 940, such as check scanners, cash receivers/counters, cash distributors, keypads/pin pads, biometric sensors (e.g., fingerprint scanners, optical/retina scanners, etc.), and so on. In one embodiment, the physical interface system 940 may be a legacy ATM device, with application programming interface (API) calls made between the AI character system and the ATM to direct the ATM to perform certain actions, while the AI character system provides the “personal touch” interaction with the user. In another embodiment, however, the physical interface system may be integrated/embedded with the AI character system, where APIs are used to directly interface with the user's financial institution (e.g., bank) in order to complete financial transactions, such as making deposits, withdrawals, balance inquiries, transfers, etc. Still further embodiments may combine various features from each system, such as using user identification and authentication techniques from the AI character system (described below), and actual paper interaction (receipts, check deposits, cash withdrawals, etc.) from the legacy ATM system.

In addition, the AI character can provide direction (e.g., like a greeter service to ensure a user is in the correct line based on their needs, or to provide the right forms such as deposit slips, etc.), or may provide advice on investments or offer other bank products just like a human bank teller or customer service representative. That is, using machine learning for concierge services as described above, including using the user's facial expressions or other visual cues to judge the success of the conversation, the techniques herein can provide a personal user experience without the need of a human representative or teller. (Note that in one example, the AI character may judge a user's displeasure with the system's ability to solve a problem based on the user's facial expressions and/or communication, and may redirect the user to a human representative, accordingly, such as, e.g., “would you like to speak to a financial advisor” or “would you prefer to discuss with a live teller?”) In general, the responses may be pre-programmed (such as “would you be interested in our special rate programs?” or “the stock market is up today, would you like to speak to a personal investment representative?”), or may be intelligently developed using any combination of machine learning interaction techniques, current events, and the user's personal information (e.g., “your stocks are underperforming the average. Have you considered speaking with a financial advisor?”, or “I see that you have been writing paper checks monthly to your mortgage company, who has just permitted online payments. Would you like to set up a recurring online transfer now?”).

According to one or more features of the embodiments herein, users may be authenticated by the AI character system through one or more advanced security and authentication measures. User authentication, in particular, may be used for initial recognition (e.g., determining who the user is without otherwise prompting for identification), such as through facial recognition, biometrics (e.g., fingerprints, thumbprints, retina scans, voice recognition, etc.), skeletal recognition, and combinations thereof. Authentication may be accomplished through access to servers and/or databases 950 operated by one or more financial institutions that are accessible by the physical interface system(s) 940 over one or more communication networks 960. Other factors may also be considered, such as for multi-authentication techniques, such as requiring the user's bank card and a user authentication, or else matching a plurality of features, such as facial recognition and biometrics combined. Still further combinations of user identification and authentication may be used, such as detecting a user device (e.g., an identified nearby smartphone associated with the user and a user's recognized face), and so on. By authenticating the user in these manners, the system herein can securely provide access to the user's financial accounts and information, and to make changes such as withdrawals, deposits, or transfers based on the user's request. In one embodiment, an initial authentication may be sufficient for certain levels of transactions (e.g., deposits, customer service, etc.), while a secondary (i.e., more secure) authentication may be required for other levels of transactions (e.g., withdrawals, transfers, etc.).

In still another embodiment, and with reference generally to FIG. 9B, the user identification may be used to limit the information shown or discussed based on other non-authorized person(s) 970 being present. For instance, in one example the system 900 may reduce the volume of the AI character if other people are detected in the nearby area (e.g., whispering), or may change to visual display only (e.g., displaying a balance as opposed to saying the balance). In yet another embodiment, the behavior of the AI character may change based on detecting an overlooking gaze from non-authorized users looking at the AI character and/or associated screen. For example, if the system is about to show, or is already showing, an account balance, but detects another non-authorized person standing behind the authorized user, and particularly looking at the screen, then the balance or other information may be hidden/removed from the screen until the non-authorized user is no longer present or looking at the screen, or depending on difference in audible distance of the authenticated user versus the non-authorized person, may be “whispered” to the user. With regard to this particular embodiment, multiple authorized users may be associated with an account, such as a husband and wife standing next to each other and reviewing their financial information together, or else a temporary user may be authorized, such as a user who doesn't mind if their close friend is there, and the user can authorize the transaction to proceed despite the presence of the unauthorized person (e.g., an exchange such as the AI character saying “I'm sorry, I cannot show the balance, as there is someone else viewing the screen” and then the user responding “It's OK, he's a friend”, and so on.)

According to an additional embodiment of the techniques herein, multi-user transactions may also be performed, such as where two authenticated users are required for a single transaction. For example, this embodiment would allow for purchases to be made between two users, where the transfer is authorized and authenticated at the same time. For instance, assume a trade show or fair, or artists market, etc. One concern by people at such events is how to exchange non-cash money, such as checks, credit cards, online transfers on phones, etc. However, checks can bounce (insufficient funds), credit cards and online transfers require both people to have the associated technology (card and card reader, apps and accounts on phones, near field communication receivers, etc.). However, with this particular embodiment, the two users can agree to meet at the AI character location (e.g., a kiosk), and then the AI character can facilitate the exchange. As an example, the two users may be authenticated (e.g., as described above), and then without sharing any financial information, a first user can authenticate the transfer of a certain amount of funds to the second user's account by requesting it from the AI character. The second user can then be told by the AI character, with confidence, that the second user's account has received the transfer, since the system has authenticated access to the second user's account for the confirmation. The transaction is then financially complete, without sharing any sensitive financial information, and both users are satisfied.

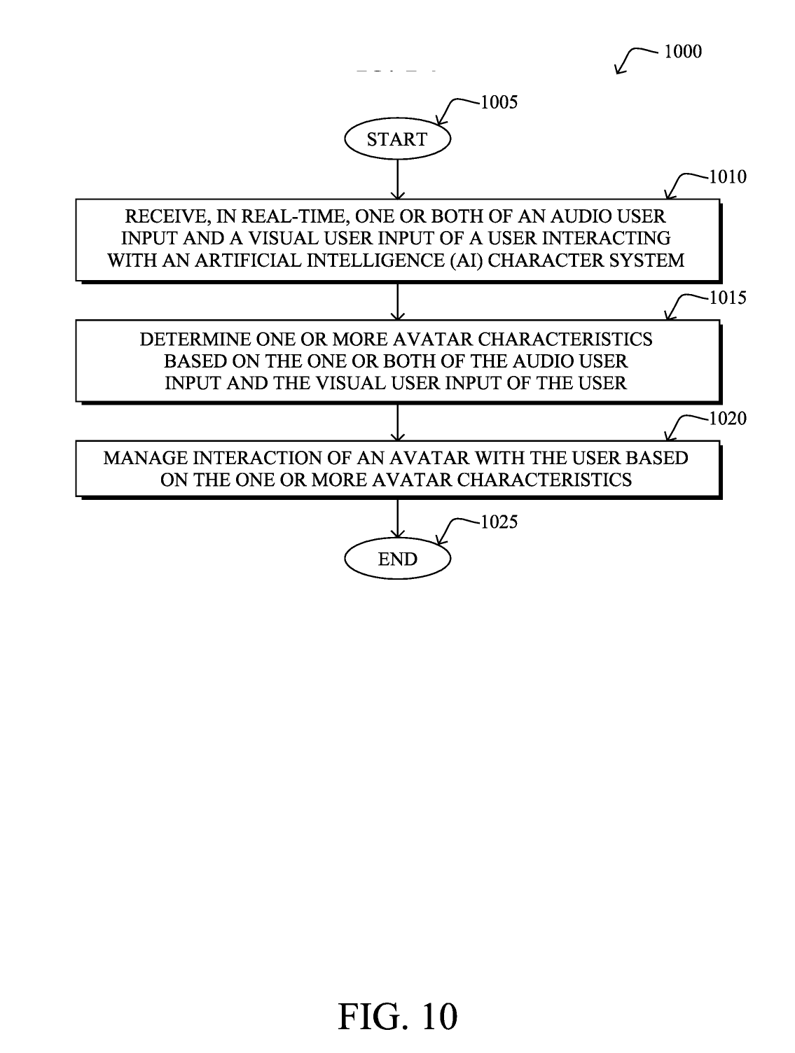

FIG. 10 illustrates an example simplified procedure for managing interaction of an avatar based on input of a user, in accordance with one or more embodiments described herein. For example, a non-generic, specifically configured device (e.g., device 400) may perform the process by executing stored instructions (e.g., processes 443). The procedure 1000 may start at step 1005, and continues to step 1010, where, as described in greater detail above, the device may receive, in real-time, one or both of an audio user input and a visual user input of a user interacting with an AI character system. In various embodiments, the audio user input and the visual user input can be collected by conventional data gathering means to generate, for example, audio files and/or image files. The audio files may capture speech of the user, while the images files may capture an image (e.g., color, infrared, etc.) of a face, body, etc. of the user. Furthermore, the device can associate and/or determine an emotion of the user based on the aforementioned audio user input (e.g., the words themselves and/or how they are spoken) or visual user input (e.g., accomplished via a facial recognition API and associated emotional processing components).

At step 1015, as described in greater detail above, the device may determine one or more avatar characteristics based on the one or both of the audio user input and the visual user input of the user. For instance, in various embodiments, the device can be configured to modify features of an avatar that is to be presented to the user based on the user(s) themselves, such as how to respond, with what emotion to display, with what words to say, with what tone to speak, with what actions or movements to make, and so on. Further, the device can be configured to select an “avatar type” of the avatar, such as a gender, an age, a real vs. imaginary (e.g., cartoon or fictional character), and so on.

At step 1020, the device may therefore manage interaction of an avatar with the user based on the one or more avatar characteristics. That is, in some embodiments, the device can control (generate) audio and visual responses of the avatar based on communication with the user, such as visually displaying/animating the avatar (2D, 3D, holographic, etc.), playing audio for the avatar's speech, etc., where the responses are based on the audio user input and/or the visual user input (e.g., the emotion of the user). Additionally, the device can operate various mechanical controls, such as for ATM control, as noted above, or other physically-integrated functionality associated with the avatar display. Procedure 1000 then ends at step 1025, notably with the ability to continue receiving A/V input from the user and adjusting interaction of the avatar, accordingly.

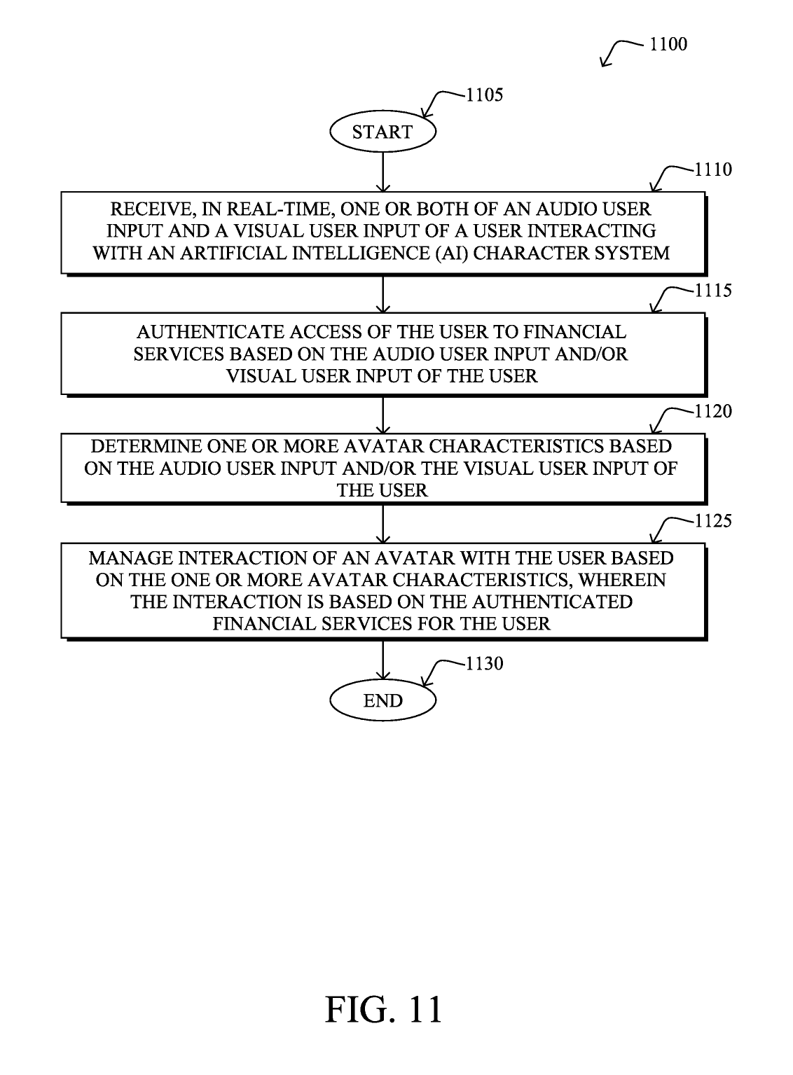

In addition, FIG. 11 illustrates another example simplified procedure for managing interaction of an avatar based on input of a user, particularly based on financial transactions in accordance with one or more embodiments described herein. For example, a non-generic, specifically configured device (e.g., device 400) may perform this process by executing stored instructions (e.g., processes 443). The procedure 1100 may start at step 1105, and continues to step 1110, where, as described in greater detail above, an AI character system receives, in real-time, one or both of an audio user input and a visual user input of a user interacting with the AI character system. Additionally in procedure 1100, in step 1115, the AI character system authenticates access of the user to financial services based on the one or both of the audio user input and the visual user input of the user.

In step 1120, the AI character system may determine one or more avatar characteristics based on the one or both of the audio user input and the visual user input of the user, as described above, and may manage interaction of an avatar with the user based on the one or more avatar characteristics in step 1125, where the interaction is based on the authenticated financial services for the user (e.g., as a bank teller, an ATM, or other financial transaction based system). Note that interacting may also be based on controlling/operating various mechanical controls, such as for ATM control (e.g., accepting checks, dispensing cash, etc.), or other physically-integrated functionality associated with the avatar display. The simplified procedure 1100 may then end in step 1130, notably with the ability to adjust the interaction based on the perceived user inputs.

It should be noted that while certain steps within procedures 1000-1100 may be optional as described above, the steps shown in FIGS. 10-11 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 1000-1100 are described separately, certain steps from each procedure may be incorporated into each other procedure, and the procedures are not meant to be mutually exclusive.

While there have been shown and described illustrative embodiments, it is to be understood that various other adaptations and modifications may be made within the spirit and scope of the embodiments herein. For example, while the embodiments have been described in terms of particular video capture devices, video display devices, holographic image projection systems, model rendering protocols, etc., other suitable devices, systems, protocols, etc., may also be used in accordance with the techniques herein. Specifically, for example, the terms “morph target” and “morph target animation” may be used interchangeably with “morph”, “morphing,” “blend shape”, “blend shaping”, and “blend shape animation”. Moreover, both two-dimensional characters/models and three-dimensional characters/models may be used herein, and any illustration provided above as either a two-dimensional or three-dimensional object is merely an example.

Further, while certain physical interaction systems are shown in coordination with the AI character above (e.g., a bank teller or ATM), other physical interaction systems may be used herein, such as hotel concierge systems (e.g., programming and providing a key to an authorized user, printing room receipts, making dinner reservations through online platforms such as OpenTable®, etc.), rental car locations (e.g., providing authorized users with car keys for their selected vehicle, printing agreements, etc.), printing movie tickets, in-bar breathalyzer tests, and so on.

It should also be noted that while certain steps within procedures detailed above may be optional as described above, the steps shown in the figures are merely examples for illustration, and certain other steps may be included or excluded as desired. Further, while a particular order of the steps is shown, this ordering is merely illustrative, and any suitable arrangement of the steps may be utilized without departing from the scope of the embodiments herein. In addition, the procedures outlined above may be used in conjunction with one another, thus it is expressly contemplated herein that any of the techniques described separately herein may be used in combination, where certain steps from each procedure may be incorporated into each other procedure, and the procedures are not meant to be mutually exclusive.

The foregoing description has been directed to specific embodiments. It will be apparent, however, that other variations and modifications may be made to the described embodiments, with the attainment of some or all of their advantages. For instance, it is expressly contemplated that certain components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
receiving, in real-time by an artificial intelligence (AI) character system, one or both of an audio user input and a visual user input of a user interacting with the AI character system;
determining, by the AI character system, one or more avatar characteristics based on the one or both of the audio user input and the visual user input of the user; and
managing, by the AI character system, interaction of an avatar with the user based on the one or more avatar characteristics.

2. The method as in claim 1, further comprising:
associating, by the AI character system, a categorized emotion with the user based on the one or both of the audio user input and the visual user input of the user, wherein determining the one or more avatar characteristics is based on the associated categorized emotion.

3. The method as in claim 2, wherein associating the categorized emotion with the user based on the one or both of the audio user input and the visual user input of the user comprises:
implementing a machine learning process to categorize the categorized emotion.

4. The method as in claim 3, wherein input data for the machine learning process comprises historical activity of the user.

5. The method as in claim 1, wherein the one or both of the user audio input and the visual user input is selected from a group consisting of: speech of the user, facial images of the user, body tracking of the user, and eye-tracking data of the user.

6. The method as in claim 1, wherein the one or more avatars characteristics is selected from a group consisting of: a tone of the avatar, an avatar type of the avatar, an expression of the avatar, and an avatar body movement or position.

7. The method as in claim 1, wherein managing the interaction of the avatar with the user based on the one or more avatar characteristics comprises:
controlling audio and visual responses of the avatar based on communication with the user based on the one or more avatar characteristics.

8. The method as in claim 1, wherein managing the interaction of the avatar with the user based on the one or more avatar characteristics comprises:
animating the avatar using one or both of morph target animation and three-dimensional (3D) rigging.

9. The method as in claim 1, wherein managing the interaction of the avatar with the user based on the one or more avatar characteristics comprises:
generating, by the AI character system, a holographic projection of the avatar based on a Pepper's Ghost Illusion technique.

10. The method as in claim 1, wherein the avatar is a bank teller.

11. The method as in claim 1, wherein managing the interaction of the avatar with the user based on the one or more avatar characteristics comprises:
operating one or more mechanical controls according to the interaction of the avatar with the user.

12. A tangible, non-transitory computer-readable media comprising program instructions, which when executed on a processor are configured to:
receive, in real-time, one or both of an audio user input and a visual user input of a user interacting with an artificial intelligence (AI) character system;
determine one or more avatar characteristics based on the one or both of the audio user input and the visual user input of the user; and
manage interaction of an avatar with the user based on the one or more avatar characteristics.

13. The computer-readable media as in claim 12, wherein the program instructions when executed on the processor are further configured to:
associate a categorized emotion with the user based on the one or both of the audio user input and the visual user input of the user, wherein the program instructions when executed to determine the one or more avatar characteristics is based on the associated categorized emotion.

14. The computer-readable media as in claim 13, wherein the program instructions when executed to associate the categorized emotion with the user based on the one or both of the audio user input and the visual user input of the user are further configured to:
implement a machine learning process to categorize the categorized emotion.

15. The computer-readable media as in claim 14, wherein input data for the machine learning process comprises historical activity of the user.

16. The computer-readable media as in claim 12, wherein the one or more avatar characteristics is selected from a group consisting of: a tone of the avatar, an avatar type of the avatar, an expression of the avatar, and a body movement or position of the avatar.

17. The computer-readable media as in claim 12, wherein the program instructions when executed to manage the interaction of the avatar with the user based on the one or more avatar characteristics are further configured to:
control audio and visual responses of the avatar based on communication with the user based on the one or more avatar characteristics.

18. The computer-readable media as in claim 12, wherein the avatar is a bank teller.

19. The computer-readable media as in claim 12, wherein the program instructions when executed to manage the interaction of the avatar with the user based on the one or more avatar characteristics are further configured to:
operate one or more mechanical controls according to the interaction of the avatar with the user.

20. A method, comprising:
receiving, in real-time by an artificial intelligence (AI) character system, one or both of an audio user input and a visual user input of a user interacting with the AI character system;
authenticating, by the AI character system, access of the user to financial services based on the one or both of the audio user input and the visual user input of the user;
determining, by the AI character system, one or more avatar characteristics based on the one or both of the audio user input and the visual user input of the user; and
managing, by the AI character system, interaction of an avatar with the user based on the one or more avatar characteristics, wherein the interaction is based on the authenticated financial services for the user.
